(19) United States
(12) Patent Application Publication
(10) Pub. No.: US 2016/0141116 A1
(43) Pub. Date: May 19, 2016

(54) METAL POWDER, ELECTRONIC COMPONENT AND METHOD OF PRODUCING THE SAME

(71) Applicant: SAMSUNG ELECTRO-MECHANICS CO., LTD., Suwon-Si (KR)

(72) Inventors: Kwi Jong LEE, Suwon-Si (KR); Sung Il OH, Suwon-Si (KR)

(21) Appl. No.: 14/932,923

(22) Filed: Nov. 4, 2015

Related U.S. Application Data
(62) Division of application No. 13/717,059, filed on Dec. 17, 2012, now abandoned.

(30) Foreign Application Priority Data
Aug. 17, 2012 (KR) 10-2012-0090324

(51) Int. Cl. H01G 13/00

(52) U.S. Cl. CPC H01G 13/006

(57) ABSTRACT

There is provided an electronic component including: a ceramic body; internal electrodes formed within the ceramic body; and external electrodes electrically connected to the internal electrodes, formed on external surfaces of the ceramic body, and including a metal powder having nano protrusions formed of an organic metal on a surface of a metal particle.

### CROSS-REFERENCE TO RELATED APPLICATIONS

This application is a Division of U.S. patent application Ser. No. 13/717,059, filed on Dec. 17, 2012, which in turn claims the priority of Korean Patent Application No. 10-2012-0090324 filed on Aug. 17, 2012, in the Korean Intellectual Property Office, the disclosure of which Applicants are incorporated herein by reference.

### BACKGROUND OF THE INVENTION

1. Field of the Invention

The present application relates to a metal powder, an electronic component using the metal powder, and a method of producing the same.

2. Description of the Related Art

Recently, in accordance with a trend for the miniaturization and multifunctionalization of electronic products, electronic components thereof have also been required to be miniaturized and multi-functionalized.

In accordance with the miniaturization and high integration of electronic components, an electronic circuit having increased electrical conductivity has been demanded. In the case of a ceramic electronic component, a contact part between the electronic component and a substrate may be coated and sintered using a copper powder paste for conductivity therebetween, and a nickel/tin/gold plating method may be then performed. However, cracks may be generated at the time of the sintering process due to a difference in sintering shrinkage between the copper powder paste and a ceramic body. In addition, a material having excellent flexibility rather than a sintered electrode material of the related art has recently been required in a field of application having a wide temperature range and experiencing vibrations, such as the automotive field. A low temperature-curable paste such as a silver (Ag) epoxy has been used for sintering cracks or flexibility. However, due to sudden rises in the cost of raw materials, materials capable of replacing silver (Ag) have been reviewed, and as a replacement material, Ag-coated copper, or the like, has been developed.

According to the related art, copper has a problem in terms of conductivity and oxidation properties when being directly applied as an epoxy.

To bolster conductivity and oxidation properties, a particle or a flake having a size of several micrometers or more has been used. However, in the case of large particles, a plating thickness of an electrode may be extremely thick when applied to a small sized electronic component.

Therefore, there is need to use a copper powder having a relatively small particle size appropriate for forming an electrode of a small sized electronic component simultaneously with improving conductivity.

### RELATED ART DOCUMENT

(Patent Document 1) Japanese Patent Laid-Open Publication No. JP 1996-143792

### SUMMARY OF THE INVENTION

An aspect of the present invention provides a metal powder capable of improving conductivity.

Another aspect of the present invention provides an electronic component having excellent reliability and a method of producing the same.

According to an aspect of the present invention, there is provided a metal powder including: a metal particle; and nano protrusions formed on a surface of the metal particle, wherein the nano protrusions are formed of an organic metal.

The metal particle may be a copper particle.

The organic metal may be organic copper.

According to another aspect of the present invention, there is provided an electronic component including: a ceramic body; internal electrodes formed within the ceramic body; and external electrodes electrically connected to the internal electrodes, formed on external surfaces of the ceramic body, and including a metal powder having nano protrusions formed of an organic metal on a surface of a metal particle.

The metal particle may be a copper (Cu) particle.

The metal particle may contact another metal particle adjacent thereto through the nano protrusions.

According to another aspect of the present invention, there is provided a method of producing an electronic component, the method comprising: preparing a plurality of ceramic green sheets; forming internal electrodes on the ceramic green sheets using a metal paste; forming a laminate by stacking the ceramic green sheets having the internal electrodes formed thereon; sintering the laminate; coating a conductive paste including a binder, a solvent, a copper particle, and organic copper on an external surface of the sintered body; and forming a metal powder having nano protrusions by heat treating the conductive paste.

According to another aspect of the present invention, there is provided a method of producing an electronic component, the method including: method of producing an electronic component, the method comprising: preparing a plurality of ceramic green sheets; forming internal electrodes on the ceramic green sheets using a nickel paste; forming a laminate by stacking the ceramic green sheets having the internal electrodes formed thereon; sintering the laminate; and forming external electrodes using a conductive paste including a binder, a solvent, and a metal powder having nano protrusions formed of organic copper on a surface of a copper particle.

The method may further include: mixing the copper particle and the organic copper and coating the organic copper on the surface of the copper particle; and heat treating the coated copper particle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a multilayered ceramic capacitor according to an embodiment of the present invention;

FIG. 2 is a schematic cross-sectional view showing the multilayered ceramic capacitor taken along line A-A′ of FIG. 1;

FIGS. 3A and 3B are views showing a general metal powder;

FIGS. 4A and 4B are views showing a metal powder according to an embodiment of the present invention;

FIGS. 5A-5G show a process diagram of a method of producing the multilayered ceramic capacitor according to the embodiment of the present invention;

FIG. 6 shows a metal powder having nano protrusions formed in Example 1; and

FIG. 7 shows a metal powder having nano protrusions formed in Example 2.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Hereinafter, an electronic component according to an embodiment of the present invention and a method of producing the same will be described. In particular, a method of producing a multilayered ceramic capacitor will be described. However, the present invention is not limited thereto.

For example, the multilayered ceramic capacitor and the method of producing the same are described by way of example in the following embodiment of the present invention. However, the present invention is not limited thereto, as long as the electronic component has an electrode formed in a ceramic, polymer body, various kinds of electronic component may be used.

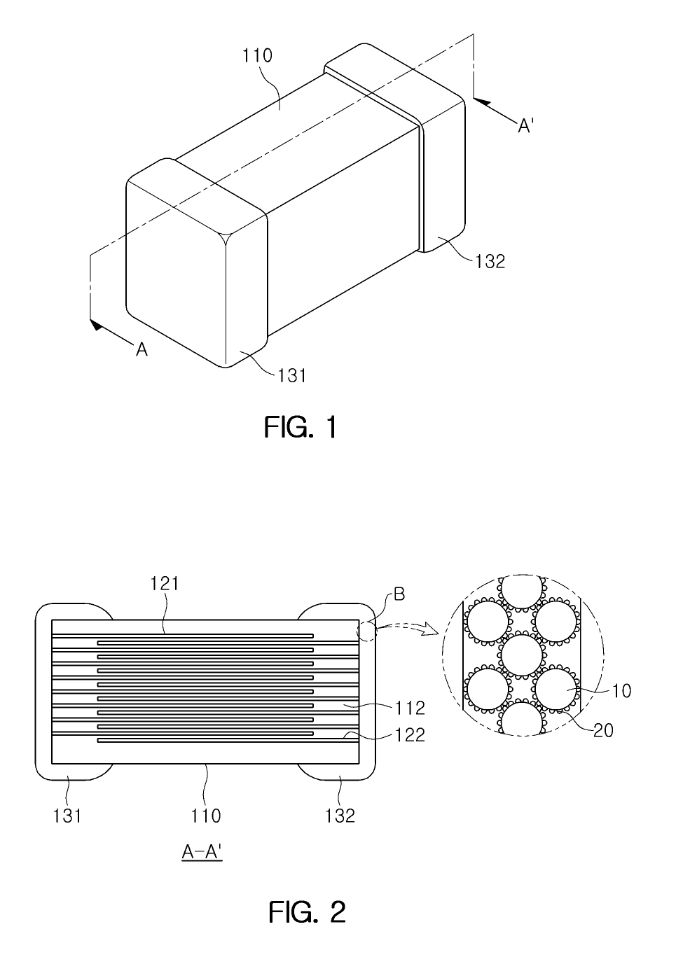

FIG. 1 is a schematic perspective view showing the multilayered ceramic capacitor according to the embodiment of the present invention.

FIG. 2 is a schematic cross-sectional view showing the multilayered ceramic capacitor taken along line A-A′ of FIG. 1.

Referring to FIGS. 1 and 2, the multilayered ceramic capacitor according to the embodiment of the present invention may include a ceramic body 110 in which a plurality of dielectric layers are stacked, a plurality of internal electrodes 121 and 122 formed on the dielectric layers, and external electrodes 131 and 132 formed on surfaces of the ceramic body 110.

The ceramic body 110 may generally have a rectangular parallelepiped shape, but is not limited thereto. In addition, the ceramic body may have a size of 0.6 mm×0.3 mm and may be a highly multilayered ceramic capacitor having a high capacitance of over 22.5 μF. However, the present invention is not limited thereto.

The ceramic body 110 may be formed by stacking the plurality of dielectric layers 112. The plurality of dielectric layers 112 configuring the ceramic body 110 are in a sintered state and may be integrated so that a boundary between dielectric layers adjacent to each other may not be readily apparent.

Each of the dielectric layers 112 may be formed by sintering a ceramic green sheet including a ceramic powder.

The ceramic powder may be a ceramic powder generally used in the art. As the ceramic powder, a BaTiO₃-based ceramic powder may be used. However, the present invention is not limited thereto. BaTiO₃-based ceramic powders may include (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, and the like, in which Ca, Zr, or the like, is partially employed in BaTiO₃, but are not limited thereto. An average particle size of the ceramic powder may be 1.0 μm or less, but is not limited thereto.

In addition, the ceramic green sheet may include a transition metal oxide or carbide, rare-earth elements, Mg, Al, or the like, in addition to the ceramic powder.

A thickness of each dielectric layer 112 may be appropriately changed according to a capacitance design of the multilayered ceramic capacitor. For example, the thickness of each dielectric layer 112 after a sintering process may be 1.0 μm or less, but is not limited thereto.

The plurality of internal electrodes 121 and 122 may be formed within the ceramic body 110. The internal electrodes 121 and 122 may be formed on the respective dielectric layers 112 and formed within the ceramic body 110 while having each dielectric layer 112 therebetween through sintering.

The internal electrodes 121 and 122 may include pairs of a first internal electrode 121 and a second internal electrode 122 having different polarities, and disposed to face each other according to a direction in which the dielectric layers are stacked. Distal ends of the first and second internal electrodes 121 and 122 may be alternately exposed to opposing end surfaces of the ceramic body 110.

Thicknesses of the internal electrodes 121 and 122 may be appropriately determined according to the use thereof, and, for example, may be 1.0 μm or less. Otherwise, the thicknesses of the internal electrodes 121 and 122 may be selected within a range of 0.1 to 1.0 μm.

The internal electrodes 121 and 122 may be formed using a metal paste. For example, the metal paste may be printed on the ceramic green sheet and sintered to form the internal electrodes 121 and 122. Printing methods may include a screen printing method, a gravure printing method, and the like.

The internal electrodes 121 and 122 may be formed by using a conductive metal. As the conductive metal, silver (Ag), lead (Pb), platinum (Pt), nickel (Ni), copper (Cu), or the like, may be used alone or in a mixture of two or more thereof, but is not limited thereto.

The external electrodes 131 and 132 may be formed on surfaces of the ceramic body 110 to be electrically connected to the internal electrodes 121 and 122. More specifically, the external electrodes 131 and 132 may include the first external electrode 131 electrically connected to the first internal electrode 121 exposed to one surface of the ceramic body 110 and the second external electrode 132 electrically connected to the second internal electrode 122 exposed to the other surface of the ceramic body 110.

The external electrodes 131 and 132 may be formed by using the conductive paste according to the embodiment of the present invention. Conductive materials included in the conductive paste may include Ni, Cu, and an alloy thereof, but are not limited thereto. The thicknesses of the external electrodes 131 and 132 may be appropriately determined to use thereof, or the like.

A conductive paste composition for an external electrode according to the embodiment of the present invention may include a binder, a solvent, and a metal powder having nano protrusions formed of an organic metal on a surface of a metal particle.

As the metal particle and the organic metal usable in the metal powder, a copper particle and organic copper may be used, but is not limited thereto.

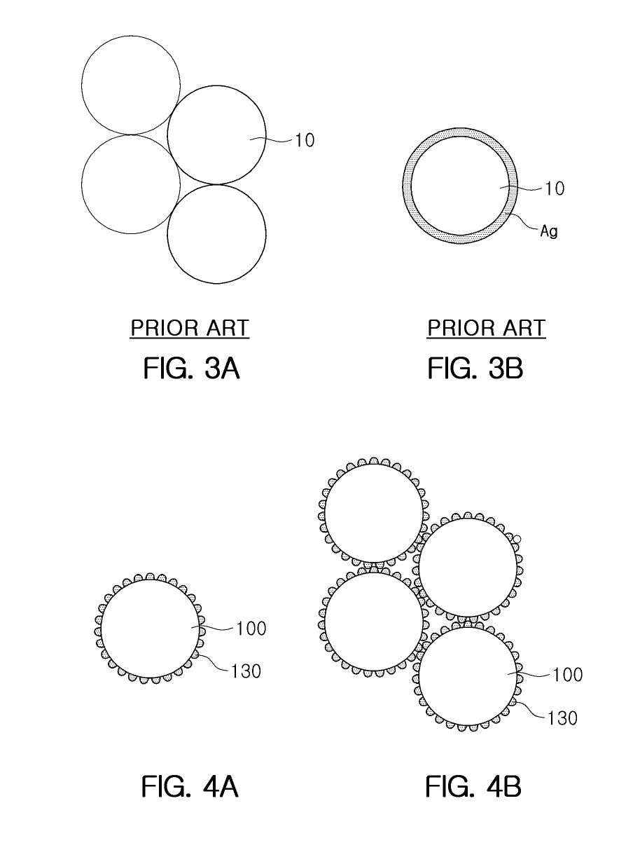

FIG. 3 is a view showing a general metal powder.

FIG. 3A shows a state in which metal particles contained in the metal powder are in contact with each other.

As shown in FIG. 3A, in the case of forming external electrodes, or the like, by using a general metal powder, metal particles 10 adjacent to each other may contact each other. In addition, the external electrodes may have conductivity due to the contact between the metal particles 10.

As a method of improving conductivity, a surface treatment may be performed on the metal particles by using a material having excellent conductivity, and the contact between the metal particles may be increased.

For example, as shown in FIG. 3B, a silver (Ag) coating film may be formed on a surface of the metal particle 10, for example, copper. However, since the formation of the coating film does not significantly improve contact efficiency between metal particles, which has a limitation in improving electrode conductivity.

Meanwhile, Such a surface coating treatment may be not intended to increase contact between metal particles but to prevent oxidation of a metal particle or to decrease a required amount of noble metals such as silver (Ag).

FIG. 4 is a view showing a metal powder according to an embodiment of the present invention.

Referring to FIG. 4A, the metal powder according to the embodiment of the present invention may include the metal particles 10 and nano protrusions 20.

The metal particles 10 may be formed of copper (Cu).

The nano protrusions 20 may preferably be formed of an organic metal. In addition, the nano protrusions 20 may preferably be formed of organic copper.

According to a metal plating method of the related art, a structure in which the metal particle is entirely coated may be only formed.

Therefore, a new material has been required in order to form the nano protrusions on the surface of the metal particle.

According to the embodiment of the present invention, the organic metal may be used to form the nano protrusions on the metal particle. This is because that a molecular structure of the organic metal is controlled to thereby control compatibility with a solvent and a decomposition temperature.

FIG. 4B is a view showing a state in which the metal particles contained in the metal powder are in contact with each other according to the embodiment of the present invention.

As shown in FIG. 4B, the metal particles contained in the metal powder may contact with each other by using the nano protrusions. Therefore, contact efficiency of the metal particles may be significantly improved.

Referring to FIG. 2, through an enlarged view of part B, the external electrodes formed by using the metal powder according to the embodiment of the present invention may be confirmed.

As shown in the enlarged view, the metal particles contained in the metal powder may contact each other through the nano protrusions 20.

Here, contact efficiency of the metal particles is improved, whereby conductive properties of the external electrodes 131 and 132 may be improved.

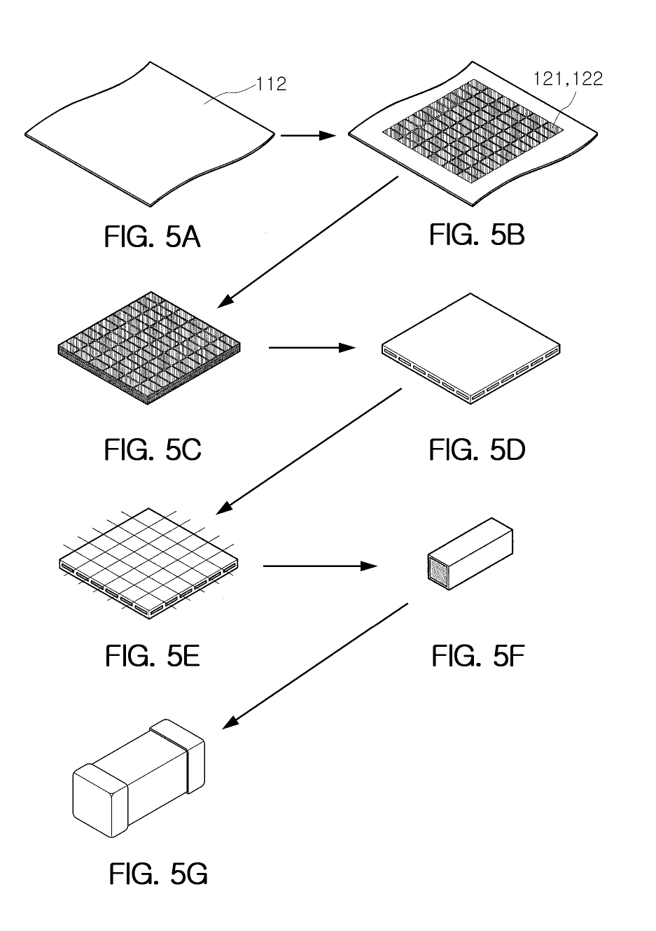

FIG. 5 is a process diagram showing a method of producing of the multilayered ceramic capacitor according to the embodiment of the present invention.

Referring to FIG. 5, a method of producing a multilayered ceramic capacitor according to the embodiment of the present invention may include: preparing a plurality of ceramic green sheets; forming internal electrodes on the ceramic green sheets using a nickel paste composition; forming a laminate by stacking the ceramic green sheets having the internal electrodes formed thereon; sintering the laminate; forming external electrodes using a conductive paste composition; and sintering the external electrodes.

Meanwhile, the conductive paste composition may include a binder, a solvent, a metal particle, and an organic metal.

In this case, the conductive paste composition is dried and heat-treated in a state in which the metal particle and the organic metal are mixed in the solvent. Here, a metal powder having nano protrusions may be produced due to an action of the metal particle and the organic metal included in the conductive paste composition.

In this method, the metal powder having the nano protrusions is formed at the time of forming the external electrodes, whereby contact efficiency between metal particles may be significantly increased.

Otherwise, the conductive paste composition may include a binder, a solvent, and a metal powder having nano protrusions formed of an organic metal on a surface of a metal particle.

In this case, the metal powder having nano protrusions formed of an organic metal on the surface of the metal particle may be prepared before forming the external electrodes using the conductive paste composition.

In the preparing the metal powder having nano protrusions, mixing the metal particle and the organic metal in the solvent and coating the organic metal on the surface of the metal particle; and drying and heat treating the coated metal particle may be included.

Here, in the drying and heat treating of the coated metal particle, the organic metal is pyrolized, and the pyrolized organic metal is metalized on the surface of the metal particle, whereby the nano protrusions may be formed thereon.

As described above, the method of forming the metal powder having the nano protrusions in advance may minutely control the amount of the metal powder included in the conductive paste. That is, the conductive paste may be appropriately formed according to an intended usage thereof.

The conductive paste may be used in the method of producing the multilayered ceramic capacitor according to the embodiment of the present invention.

Hereinafter, the method of producing the multilayered ceramic capacitor using the conductive paste will be specifically described.

According to the embodiment of the present invention, when preparing a plurality of green sheets (FIG. 5A), firstly, ceramic green sheets may be formed by mixing a powder such as a barium titanate (BaTiO₃) powder, or the like, with a ceramic additive, an organic solvent, a plasticizer, a binder or a dispersant, such that the dielectric layers 112 respectively having a thickness of several μm may be formed.

In addition, the internal electrodes 121 and 122 may be formed by a nickel paste on the ceramic green sheets (FIG. 5B).

After the internal electrode layers 121 and 122 are formed as described above, a green sheet laminate may be formed by separating the green sheets from carrier films and then stacking a plurality of the green sheets on one another in an overlapped scheme (FIG. 5C).

Then, after compressing the green sheet laminate under high temperature and high pressure conditions (FIG. 5D), the compressed green sheet laminate may be cut so as to have a predetermined size through a cutting process (FIG. 5E), such that a green chip is produced (FIG. 5F).

Then, the green chip may be fired to be prepared as a ceramic body.

Then, first and second external electrodes may be formed to cover surfaces of the ceramic body and to be electrically connected to the first and second internal electrodes exposed to the surfaces of the ceramic body (FIG. 5G). The first and second external electrodes may be formed using the conductive paste according to the embodiment of the present invention. After that, a plating treatment with nickel, tin, or the like may be performed on a surface of the external electrode.

Hereinafter, although the present invention will be described in detail through Inventive Examples, this description is to help understanding of the present invention, and a scope of the present invention is not limited to Inventive Examples.

In Inventive Examples of the present invention, formation of a structure of the metal powder having nano protrusions and a conductive effect obtained therefrom may be appreciated.

### Inventive Example 1

In Inventive Example 1, a metal powder having nano protrusions was prepared in advance.

Firstly, a copper alloy powder and organic copper were put into an ethanol solvent, and stirred together by a mixer.

After completing the stirring process, ethanol in the stirred product was dried, and then heat treatment was performed on the stirred product at 200° C.

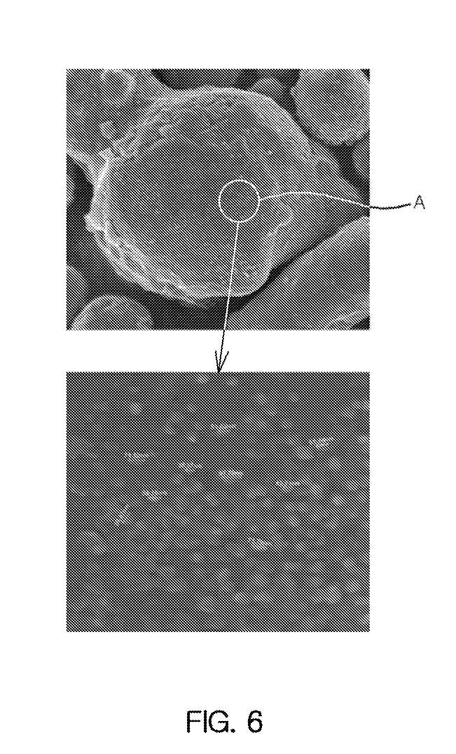

FIG. 6 shows the metal powder having the nano protrusions formed in Example 1.

As can be appreciated from FIG. 6, the nano protrusions having a size of several tens of nm were formed on a surface of the copper alloy powder.

Meanwhile, the copper powder having the nano protrusions prepared through the above-described processes was mixed with an epoxy to produce an electrode and a resistance value of the produced electrode was then measured. In addition, a general copper powder not having the nano protrusions was mixed with an epoxy and a resistance value after forming an electrode was then measured.

The electrode according to the embodiment of the present invention had a low resistance value of about 100 ohms. Meanwhile, the electrode using the metal powder not having the nano protrusions had a resistance value of 1000 ohms or more.

Therefore, it may be appreciated that in the case of forming the electrode using the metal powder having the nano protrusions, the resistance value was significantly lowered.

### Inventive Example 2

In Inventive Example 2, a metal powder having nano protrusions is formed in a method of producing an electrode using a conductive paste.

Firstly, a copper alloy powder and organic copper were mixed with an epoxy solvent, stirred, and 3-roll milled to prepare an epoxy paste.

The prepared epoxy paste was coated on dielectric layers, and a heat-treatment was performed thereon at 200° C. After that, the metal powder having the nano protrusions was confirmed by a scanning electron microscope (SEM).

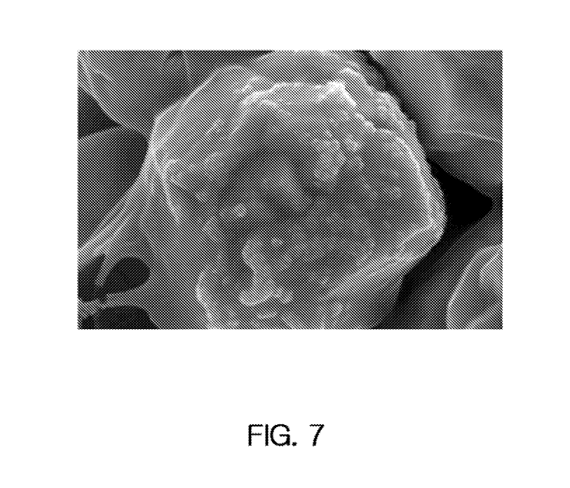

FIG. 7 shows the metal powder having the nano protrusions formed in Example 2.

As can be appreciated from FIG. 7, the nano protrusions having a size of several tens of nm were formed on a surface of the copper alloy powder.

Meanwhile, a resistance value of an electrode produced through the above-described processes was measured. In addition, a resistance value of an electrode produced by using a conductive paste without an organic metal was measured.

The electrode according to the embodiment of the present invention had a low resistance value of about 50 ohms. Meanwhile, the electrode produced by using the conductive paste without the organic metal had a resistance value of 4500 ohms.

Therefore, it may be appreciated that in the case of forming the electrode by using the conductive paste including the organic metal, the resistance value was significantly lowered.

Meanwhile, when comparing Inventive Example 1 with Inventive Example 2, it may be appreciated that the case of using the conductive paste including the metal particle and the organic metal was more advantageous than the case of using the conductive paste including the metal powder having the nano protrusions, in terms of conductivity.

As set forth above, according to the metal powder according to the embodiments of the present invention, electrodes having improved conductivity can be formed.

In addition, according to the method of producing the electronic component according to the embodiments of the present invention, electrode conductivity is improved, whereby the electronic component having excellent reliability can be implemented.

While the present invention has been shown and described in connection with the embodiments, it will be apparent to those skilled in the art that modifications and variations can be made without departing from the spirit and scope of the invention as defined by the appended claims.

What is claimed is:

1. A method of producing an electronic component, the method comprising:
preparing a plurality of ceramic green sheets;
forming internal electrodes on the ceramic green sheets using a metal paste;
forming a laminate by stacking the ceramic green sheets having the internal electrodes formed thereon;
sintering the laminate;
coating a conductive paste including a binder, a solvent, a copper particle, and organic copper on an external surface of the sintered body; and
forming a metal powder having nano protrusions by heat treating the conductive paste.

2. A method of producing an electronic component, the method comprising:
preparing a plurality of ceramic green sheets;
forming internal electrodes on the ceramic green sheets using a nickel paste;
forming a laminate by stacking the ceramic green sheets having the internal electrodes formed thereon;
sintering the laminate; and
forming external electrodes using a conductive paste including a binder, a solvent, and a metal powder having nano protrusions formed of organic copper on a surface of a copper particle.

3. The method of claim 2, further comprising:
mixing the copper particle and the organic copper and coating the organic copper on the surface of the copper particle; and
heat treating the coated copper particle.
